(19) United States
(12) Patent Application Publication
(10) Pub. No.: US 2012/0233552 A1
(43) Pub. Date: Sep. 13, 2012

(54) PERSONALIZING THE USER EXPERIENCE

(75) Inventors: Jaime Chee, San Diego, CA (US); Jason Clement, San Diego, CA (US); Steven Richman, San Diego, CA (US)

(73) Assignee: SONY CORPORATION, Tokyo (JP)

(21) Appl. No.: 13/042,181

(22) Filed: Mar. 7, 2011

(51) Int. Cl. G06F 3/01

(52) U.S. Cl. 715/745

(57) ABSTRACT

A database device generates a personalized remote user interface corresponding to a user. The database device discovers devices in a network and receives device information and user information from the devices. The database device generates a profile based on the device information and the user information. Using the profile, the database device generates a personalized remote user interface. After the personalized remote user interface is sent to a rendering device, the personalized remote user interface displays a remote user interface specific to the user.

### FIELD OF THE INVENTION

The present invention relates to the field of remote user interfaces. More specifically, the present invention relates to a device for personalizing a remote user interface.

### BACKGROUND OF THE INVENTION

The number of electronic devices in people's homes is continually increasing. Many years ago, homes only had a radio; then, a radio and a television. The number of devices has increased to the point where a typical home has several televisions, stereos, computers, video game consoles, mobile phones/devices, appliances and others. Furthermore, these devices are gaining intelligence so that they are able to communicate with each other.

The expansion of residential networks to include a multiplicity of devices that can share files asynchronously and connect to the Internet through residential gateways was facilitated by the de-facto standard use of wired and wireless ethernet connectivity. Asynchronous sharing then started to give way to buffered streaming of video as bandwidth availability improved. This was closely followed by real time streaming. Networks employ quality of service to manage bandwidth resource and Universal Plug and Play (UPnP) to perform discovery and compatibility of compressed video content. Video UPnP also defines remote user input operation like play, stop and rewind so that video control as well as video display is able to be performed remotely. Also, provisions were made to support graphical transfer of a remote user interface, but no implementations on the market have made use of this. UPnP allowed for many different standards of compressed video, but does not, however, certify that a client supported the relevant decoder. Digital Living Network Alliance (DLNA) is a standards body formed to provide certified device compatibility for a specific subset of UPnP implementations. It also defined the role of media servers, renderers, adapters, players and controllers.

A standard, referred to as Remote User Interface (RUI or Remote UI) is being developed to allow devices to operate each other and provide the user with a user interface that is configured appropriately for a device being used to control another device. For example, a user interface for a 46″ wide television is not likely to appear properly on a mobile phone which has a display of 2″. The Remote UI standard is a web-based protocol and framework for remote user interface on UPnP Networks and the Internet. The standard allows a UPnP-capable home network device to provide its interface (display and control options) as a web page to display on any other device coupled to the home network.

There are no well defined and widely accepted UPnP implementations for graphical RUI. One option, which has been backed by the UPnP Forum, is a browser based implementation known as CEA2014. The network client browser is considered to be heavy in flash, memory and/or processor requirements (‘thick’ client), whereas the network server application performs simple encapsulation of XML (‘thin’ server). In some situations this may be acceptable, like the case when rendering is performed by a personal computer and the application is run on a small mobile device, or a low end processing device, like a network router.

However, in the case of the home network where the rendering is done by a high definition TV, a Blu-Ray® player, a picture frame or a gaming machine, the use of a browser for RUI has some disadvantages. Firstly, a browser adds to the already substantial memory requirements of the renderers and so for these cost sensitive consumer electronics devices it may not be viable. Secondly, the processing speed requirements for a responsive experience are not going to be provided by the current range of devices available. And thirdly, the browser interface lends itself well to mouse and keyboard control, but is not necessarily the ideal format for a limited button remote control.

Also, the home network is able to include graphics applications built into game machines, video players, dongles and intelligent remotes on the low end, with cable boxes, cloud servers and multimedia PCs on the high end. To shoehorn all of these into one UPnP standard, it is clear that reach will be limited. In some cases substantial effort of rewriting or translation of the graphics application might be needed in order to fit the browser framework.

Another example of a proposed RUI is being provided through the RVU alliance. The RVU alliance was initiated by DirectTV in order to provide a pixel accurate remotely rendered version of their satellite decoder user interface. Unlike the browser based RUI, RVU uses a low level protocol that manipulates the graphics card framebuffer layers more directly. Instead of the script type messages that CEA2014 uses, RVU breaks up elements of the graphics into images that can be sent compressed or uncompressed over the network to be composited in the renderer's screen buffers or off screen buffers as needed. Simple bit commands are sent over the network to allow the images to be stretched, cut and alpha-blended on the renderer side. This type of RUI would be considered a thin network client and thick network server because most of the computation effort would be with the application. Also, because most actions involve sending image data, this type of RUI uses a lot of network resources.

The advantage of RVU is that the low level graphics operations are able to be supported by all graphics cards quite easily and is not directly dependent on the type of application to be able to function. However, sometimes performance is a key parameter in usability, and as such the network load and network server performance could severely limit how useful the protocol is. RVU is especially vulnerable where complete screen refreshes are needed often, like 3D rotations of a view. A browser approach could handle this more simply through scripts of simple rotation commands. Another similar limitation is when the application is providing remote graphics to multiple renderers, and causes the application processor to run short of the necessary MIPS to perform adequately.

### SUMMARY OF THE INVENTION

A database device generates a personalized remote user interface corresponding to a user. The database device discovers devices in a network and receives device information and user information from the devices. The database device generates a profile based on the device information and the user information. Using the profile, the database device generates a personalized remote user interface. After the personalized remote user interface is sent to a rendering device, the personalized remote user interface displays a remote user interface specific to the user.

In one aspect, a method of generating a personalized remote user interface comprises receiving device information and user information into a database device, generating a profile by analyzing the device information and the user information, generating a personalized remote user interface based on the profile and sending the personalized remote user interface to a rendering device. The method further comprises discovering a user device. The method further comprises rendering the personalized remote user interface on the rendering device. The method further comprises receiving the device information and the user information includes automatically receiving the device information and the user information from a user device. Receiving the device information and the user information includes a user manually entering the device information and the user information. The device information comprises at least one of a serial number, a MAC address, a device name, a device type, Transferjet information, Bluetooth® ID, RFID and FeliCa information and face/voice/biometric recognition data. The user information is associated with the device information. The database device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, Blu-ray writer/player, ebook reader, near field devices, monitoring devices, robots, a television, a home entertainment system and an intelligent appliance.

In another aspect, a network of devices comprises a source device for communicating a remote user interface command, a database device for generating a personalized remote user interface, a rendering device for rendering the personalized remote user interface and a network for operatively coupling the source device and the rendering device. The source device communicates the remote user interface command to the rendering device through the database device. The database device generates the personalized remote user interface by receiving device information and user information, generating a profile by analyzing the device information and the user information and generating the personalized remote user interface based on the profile. The device information comprises at least one of a serial number, a MAC address, a device name, a device type, Transferjet information, Bluetooth® ID, RFID and FeliCa information and face/voice/biometric recognition data. Receiving the device information and the user information includes automatically receiving the device information and the user information from the source device. The database device sends the personalized remote user interface to the rendering device. The source device, the database device and the rendering device comprise discovery capabilities. The source device, the database device and the rendering device are each selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, Blu-ray writer/player, ebook reader, near field devices, monitoring devices, robots, a television, a home entertainment system and an intelligent appliance.

In another aspect, a system programmed in a controller in a device comprises a discovery module for discovering devices, a profile generation module for generating a profile from information received form discovered devices, a personalized remote user interface generation module for generating a personalized remote user interface using the profile and a providing module for providing the personalized RUI to a rendering device. The controller is selected from the group consisting of a programmed computer readable medium and an application-specific circuit.

In yet another aspect, a database device comprises a memory for storing an application, the application for entering device information and user information into a database, generating a profile by analyzing the device information and the user information, generating a personalized remote user interface based on the profile and sending the personalized remote user interface to a rendering device and a processing component coupled to the memory, the processing component for processing the application. Entering the device information and the user information includes automatically receiving the device information and the user information from a user device. Entering the device information and the user information includes a user manually entering the device information and the user information. The device information comprises at least one of a serial number, a MAC address, a device name, a device type, Transferjet information, Bluetooth® ID, RFID and FeliCa information and face/voice/biometric recognition data.

### BRIEF DESCRIPTION OF THE DRAWINGS

FIG. 1 illustrates a block diagram of a network of devices implementing a method of personalizing an RUI using a database device according to some embodiments.

FIG. 2 illustrates a flowchart of a method of utilizing a database device to personalize an RUI according to some embodiments.

FIG. 3 illustrates a block diagram of an exemplary computing device to personalize an RUI according to some embodiments.

FIG. 4 illustrates an exemplary database utilized by the database device according to some embodiments.

### DETAILED DESCRIPTION OF THE PREFERRED EMBODIMENT

A method of customizing a Remote User Interface (Remote UI or RUI) for the purpose of personalizing the user experience is described herein. The method includes identifying devices, such as by MAC ID, device ID, Transferjet information, Bluetooth® ID, RFID and FeliCa information, face/voice/biometric recognition data and other identifiers, coupling to a remote database of device specifications and user profiles and generating a customized RUI based on results of information output from the database. A database device includes reference data. In some embodiments, the database device generates a customized/personalized RUI. In some embodiments, a personalized RUI is generated at a source device or a rendering device. A personalized RUI is able to be reused and sent to another rendering device with similar capabilities.

A database device such as a media server is the intelligence hub for the home so as to tailor the user experience with the RUI. A user's experience in operating a device is made easier and simpler as the options presented to the user better fit their needs with a personalized RUI.

Consumer electronic devices, also referred to as source devices, include presence discovery and description capabilities. A database server includes device and user profile information. In some embodiments, the database server is able to discover the source devices.

The process of customizing a remote user interface includes devices being discovered (e.g. via UPnP). Device and user recognition information is entered into a device database. Profiles are generated by analyzing the device and user information. An RUI based on the profiles is generated, and then the customized RUI is sent to a rendering device.

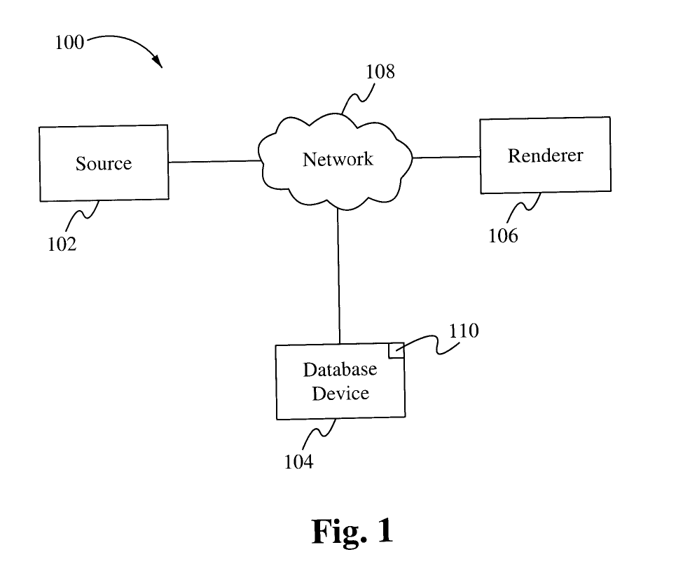

FIG. 1 illustrates a block diagram of a network of devices implementing a method of personalizing an RUI using a database device according to some embodiments. The network of devices 100 includes one or more gateway or source devices 102 coupled to a database device 104 and a renderer (e.g. a television) 106. In some embodiments, the source device 102, the database device 104 and the renderer 106 are coupled directly, and in some embodiments, the source device 102, the database device 104 and the renderer 106 are coupled through a network 108. The network 108 is able to be any type of network including, but not limited to, a LAN, a WAN, the Internet, a cellular network, a wireless network, a wired network and/or any combination thereof. In some embodiments, the network 108 is networks bridged together.

The source device 102 is any device that sends RUI data such as RUI commands to a renderer 106. The source device 102 also sends information such as device information and user information to the database device 104. In some embodiments, the RUI data is sent to a database device 104 which processes the RUI data and then sends a personalized RUI to the renderer 106. In some embodiments, the source device 102 also receives the personalized RUI from the database device 104. In some embodiments, the source device 102 is able to discover devices such as the database device 104. In some embodiments, the source device 102 is able to generate a personalized RUI using information received from the database device 104.

The database device 104 is any device that is able to store information regarding devices and users of the devices. In some embodiments, the database device 104 is able to identify users, identify devices and generate a customized RUI based on the results of the information in a database 110 regarding the users and the devices. Based on the user and the devices, the database device 104 is able to tailor the RUI specifically for that user. After the personalized RUI is generated, the personalized RUI is sent to the renderer 106. In some embodiments, the personalized RUI or at least a copy of the personalized RUI is stored in the database device 104.

The database 110 stored within the database device 104 stores and links data such as user information with device information. For example, stored in the database is a relationship between a device with a specific MAC address and the user of that device. Furthermore, the preferences of that user are stored in the database such as favorite channels.

The renderer 106 is any device that is able to render and display the personalized RUI, for example, a television.

For example, in operation, the database device 104 identifies a user's mobile device and determines the user based on the user's mobile device identification. The database device 104 contains profile information about that user, and then, the database device 104 generates a personalized RUI for that user using the profile. The personalized RUI is then sent to a television where it is displayed and the user is able to more efficiently utilize the RUI that is specifically designed for him/her.

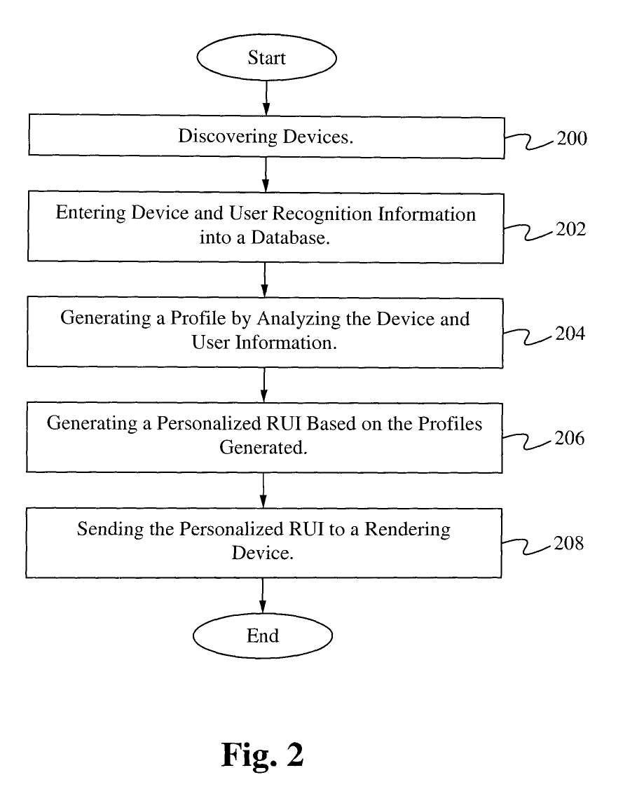

FIG. 2 illustrates a flowchart of a method of utilizing a database device to personalize an RUI according to some embodiments. In the step 200, devices are discovered. The devices are discovered using any method such as UPnP. Mobile devices are able to be discovered as well. In some embodiments, a database device discovers source and rendering devices. In some embodiments, the source devices and the rendering devices discover the database device. Any device is able to discover another device. In the step 202, device and user recognition information is entered/communicated with the database device. For example, the device and user recognition information is automatically sent from a device to the database device. In some embodiments, the device and user recognition information is manually entered by a user. In the step 204, profiles are generated by analyzing the device and user information. The profiles are able to include any kind of information such as user preferences, settings for the user and any other information that is able to improve a user's experience. In some embodiments, the profile is generated automatically based on the device information and the user information. In some embodiments, the user manually supplies information to generate the profile. In the step 206, a personalized/customized RUI based on a user's profile is generated. The customized RUI incorporates the information of the profile which results in a RUI specifically directed at the user. The customized RUI is able to provide remote functionality and/or enhancements such as recommendations and advertising. In some embodiments, the step 204 of generating profiles is skipped and the customized RUI is generated without generating profiles. In some embodiments, rendering device information is also utilized in generating the profiles, the customized RUI or both. Then, in the step 208, the customized RUI is sent to one or more rendering devices. The rendering device(s) render (e.g. display) the personalized RUI. In some embodiments, the customized RUI is also sent to the source device(s). Although specific steps are described, in some embodiments, fewer or more steps are included, and/or the order of the steps is able to be changed.

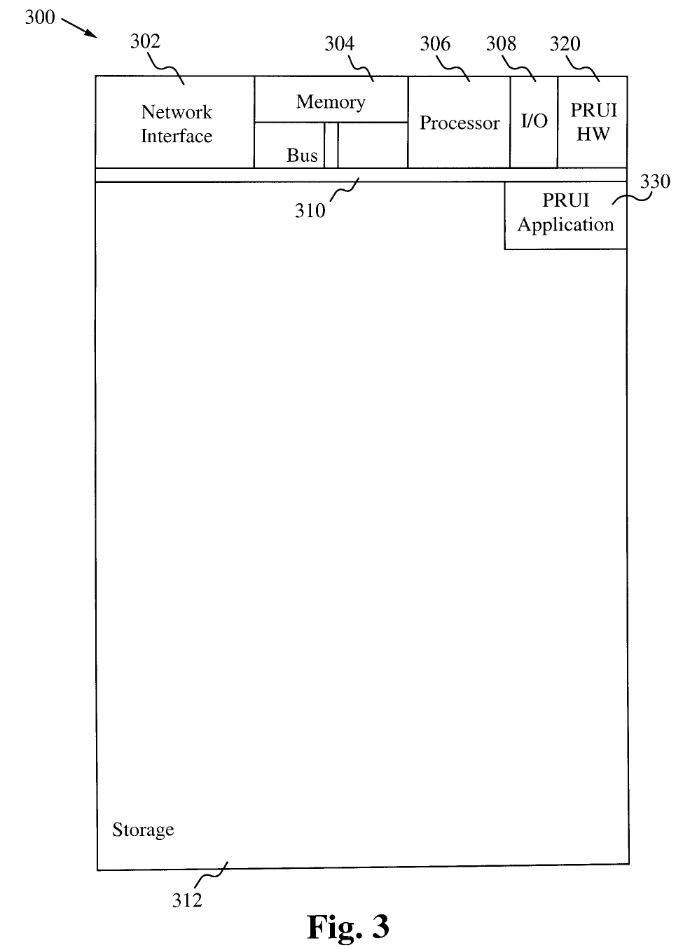

FIG. 3 illustrates a block diagram of an exemplary computing device 300 to personalize an RUI according to some embodiments. The computing device 300 is able to be used to acquire, store, compute, communicate and/or display information. For example, the computing device 300 is able to receive, generate, store, and personalize an RUI. The computing device 300 also has a database and information within the database. The information stored within the database is used to generate the personalized RUI. The personalized RUI is then able to be stored on the computing device 300. In general, a hardware structure suitable for implementing the computing device 300 includes a network interface 302, a memory 304, a processor 306, I/O device(s) 308, a bus 310 and a storage device 312. The choice of processor is not critical as long as a suitable processor with sufficient speed is chosen. The memory 304 is able to be any conventional computer memory known in the art. The storage device 312 is able to include a hard drive, CDROM, CDRW, DVD, DVDRW, Blu-ray®, flash memory card or any other storage device. The computing device 300 is able to include one or more network interfaces 302. An example of a network interface includes a network card connected to an Ethernet or other type of LAN. The I/O device(s) 308 are able to include one or more of the following: keyboard, mouse, monitor, display, printer, modem, touchscreen, button interface and other devices. Personalizing RUI application(s) 330 used to perform the personalizing RUI method are likely to be stored in the storage device 312 and memory 304 and processed as applications are typically processed. More or less components shown in FIG. 3 are able to be included in the computing device 300. In some embodiments, personalizing RUI hardware 320 is included. Although the computing device 300 in FIG. 3 includes applications 330 and hardware 320, the personalizing RUI method is able to be implemented on a computing device in hardware, firmware, software or any combination thereof. For example, in some embodiments, the personalizing RUI applications 330 are programmed in a memory and executed using a processor. In another example, in some embodiments, the personalizing hardware 320 is programmed hardware logic including gates specifically designed to implement the personalizing RUI method.

In some embodiments, the personalizing RUI application(s) 330 include several applications and/or modules. As described herein, the modules are able to include a discovery module for discovering devices, a recognition module for recognizing a device and/or a user, a profile generation module for generating a profile, a personalized RUI generation module for generating a personalized RUI, and a providing module for providing the personalized RUI to the rendering device. In some embodiments, modules include one or more sub-modules as well. In some embodiments, fewer or additional modules are able to be included.

Examples of suitable computing devices for the server device, source device and rendering device include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone, a video player, a DVD writer/player, a Blu-ray® writer/player, ebook reader, near field devices such as cards that use TransferJet, Bluetooth® ID, RFID and FeliCa, monitoring devices such as a heart monitor, robots such as Roomba, a television, a home entertainment system or any other suitable computing device. In some embodiments, a computing device is able to include intelligent appliances such as a refrigerator, a toaster, a toaster oven and a microwave, where the appliances are able to process and/or present information.

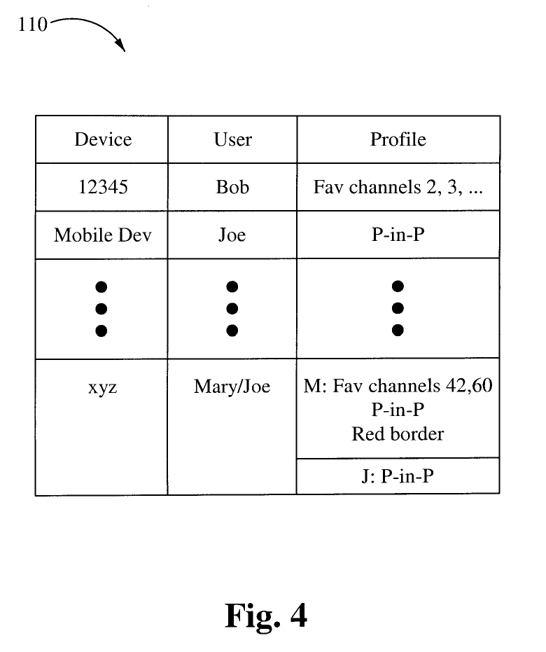

FIG. 4 illustrates an exemplary database 110 utilized by the database device according to some embodiments. The database 110 includes information related to devices, users and the profiles related to the users so that an RUI is able to be customized for that user. In the exemplary database 110, a first column includes device identification information. For example, devices are able to be identified by a serial number, a MAC address, a name, a device type, Transferjet information, Bluetooth® ID, RFID and FeliCa information, face/voice/biometric recognition data and/or any other device identifier. A second column includes user information corresponding to or associated with the device identification information. For example, each device is assigned to one or more users, or one or more users are assigned to a device. The assignment of the devices is able to be through a user interface or any other means. For example, a consumer device stores a user's name and sends the name to the database device when communicating with the database device. For some devices, multiple users use the same device. For the devices with multiple users, an implementation enables a user of the device to be determined. For example, the user is able to press a button, select their name or log in to indicate they are the user of the device. A third column includes profile information so that the personalized RUI is configured for that user. Exemplary profile information includes favorite channels, picture-in-picture options, screen size, borders, television settings and any other data. Although three columns are shown with Device, User and Profiles as labels, the database is able to have any number of columns and use any labeling. For example, additional information is able to be stored in the database such as specifications of the rendering device. Although a database is described, any data structure and configuration of the data structure is possible such as a linked list, a two dimensional array or any other data structure.

To utilize the method of personalizing an RUI, a user utilizes a source device such as a mobile device as a remote control for a television similarly to the standard use of such a device. However, the user is presented with a personalized RUI on the television instead of a generic RUI. With the personalized RUI, the user is able to enjoy a more personalized experience than with a generic RUI. In some embodiments, additional interactivity is involved with the database device, for example, the user provides his preferences/settings or indicates that he is a user of a device.

In operation, a user is recognized and then his presence is utilized by a database device to generate a personalized RUI which is displayed on a rendering device. By recognizing a user, generating the personalized RUI and displaying the personalized RUI, a user has a better experience with the rendering device. The personalized RUI is able to make navigating on the rendering device easier, provide varying appearances to the rendering device and any other modification to the rendering device. Furthermore, since the personalized RUI is generated and stored on a device separate from the user's device, the user's device does not require additional software or memory for storing personalized RUIs.

In some embodiments, the RUI is able to include physical entities such as blinking lights or moving parts. For example, a Roomba shakes when it needs attention.

In some embodiments, the devices implemented within the network described herein are able to implement Digital Living Network Alliance (DLNA) standard as well.

### Some Embodiments of Personalizing the User Experience

1. A method of generating a personalized remote user interface comprising:
   a. receiving device information and user information into a database device;
   b. generating a profile by analyzing the device information and the user information;
   c. generating a personalized remote user interface based on the profile; and
   d. sending the personalized remote user interface to a rendering device.
2. The method of clause 1 further comprising discovering a user device.
3. The method of clause 1 further comprising rendering the personalized remote user interface on the rendering device.
4. The method of clause 1 wherein receiving the device information and the user information includes automatically receiving the device information and the user information from a user device.
5. The method of clause 1 wherein receiving the device information and the user information includes a user manually entering the device information and the user information.
6. The method of clause 1 wherein the device information comprises at least one of a serial number, a MAC address, a device name, a device type, Transferjet information, Bluetooth® ID, RFID and FeliCa information and face/voice/biometric recognition data.
7. The method of clause 1 wherein the user information is associated with the device information.
8. The method of clause 1 wherein the database device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray writer/player, an ebook reader, near field devices, monitoring devices, robots, a television, a home entertainment system and an intelligent appliance.
9. A network of devices comprising:
   a. a source device for communicating a remote user interface command;
   b. a database device for generating a personalized remote user interface;
   c. a rendering device for rendering the personalized remote user interface; and
   d. a network for operatively coupling the source device and the rendering device.
10. The network of devices of clause 9 wherein the source device communicates the remote user interface command to the rendering device through the database device.
11. The network of devices of clause 9 wherein the database device generates the personalized remote user interface by:
   a. receiving device information and user information;
   b. generating a profile by analyzing the device information and the user information; and
   c. generating the personalized remote user interface based on the profile.
12. The network of devices of clause 11 wherein the device information comprises at least one of a serial number, a MAC address, a device name, a device type, Transferjet information, Bluetooth® ID, RFID and FeliCa information and face/voice/biometric recognition data.
13. The network of devices of clause 9 wherein receiving the device information and the user information includes automatically receiving the device information and the user information from the source device.
14. The network of devices of clause 9 wherein the database device sends the personalized remote user interface to the rendering device.
15. The network of devices of clause 9 wherein the source device, the database device and the rendering device comprise discovery capabilities.
16. The network of devices of clause 9 wherein the source device, the database device and the rendering device are each selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray writer/player, an ebook reader, near field devices, monitoring devices, robots, a television, a home entertainment system and an intelligent appliance.
17. A system programmed in a controller in a device comprising:
   a. a discovery module for discovering devices;
   b. a profile generation module for generating a profile from information received form discovered devices;
   c. a personalized remote user interface generation module for generating a personalized remote user interface using the profile; and
   d. a providing module for providing the personalized RUI to a rendering device.
18. The system of clause 17 wherein the controller is selected from the group consisting of a programmed computer readable medium and an application-specific circuit.
19. A database device comprising:
   a. a memory for storing an application, the application for:
      i. entering device information and user information into a database;
      ii. generating a profile by analyzing the device information and the user information;
      iii. generating a personalized remote user interface based on the profile; and
      iv. sending the personalized remote user interface to a rendering device; and
   b. a processing component coupled to the memory, the processing component for processing the application.
20. The database device of clause 19 wherein entering the device information and the user information includes automatically receiving the device information and the user information from a user device.
21. The database device of clause 19 wherein entering the device information and the user information includes a user manually entering the device information and the user information.
22. The database device of clause 19 wherein the device information comprises at least one of a serial number, a MAC address, a device name, a device type, Transferjet information, Bluetooth® ID, RFID and FeliCa information and face/voice/biometric recognition data.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of generating a personalized remote user interface comprising:
a. receiving device information and user information into a database device;
b. generating a profile by analyzing the device information and the user information;
c. generating a personalized remote user interface based on the profile; and
d. sending the personalized remote user interface to a rendering device.

2. The method of claim 1 further comprising discovering a user device.

3. The method of claim 1 further comprising rendering the personalized remote user interface on the rendering device.

4. The method of claim 1 wherein receiving the device information and the user information includes automatically receiving the device information and the user information from a user device.

5. The method of claim 1 wherein receiving the device information and the user information includes a user manually entering the device information and the user information.

6. The method of claim 1 wherein the device information comprises at least one of a serial number, a MAC address, a device name and a device type.

7. The method of claim 1 wherein the user information is associated with the device information.

8. The method of claim 1 wherein the database device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray writer/player, an ebook reader, near field devices, monitoring devices, robots, a television, a home entertainment system and an intelligent appliance.

9. A network of devices comprising:
a. a source device for communicating a remote user interface command;
b. a database device for generating a personalized remote user interface;
c. a rendering device for rendering the personalized remote user interface; and
d. a network for operatively coupling the source device and the rendering device.

10. The network of devices of claim 9 wherein the source device communicates the remote user interface command to the rendering device through the database device.

11. The network of devices of claim 9 wherein the database device generates the personalized remote user interface by:
a. receiving device information and user information;
b. generating a profile by analyzing the device information and the user information; and
c. generating the personalized remote user interface based on the profile.

12. The network of devices of claim 11 wherein the device information comprises at least one of a serial number, a MAC address, a device name and a device type.

13. The network of devices of claim 9 wherein receiving the device information and the user information includes automatically receiving the device information and the user information from the source device.

14. The network of devices of claim 9 wherein the database device sends the personalized remote user interface to the rendering device.

15. The network of devices of claim 9 wherein the source device, the database device and the rendering device comprise discovery capabilities.

16. The network of devices of claim 9 wherein the source device, the database device and the rendering device are each selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray writer/player, an ebook reader, near field devices, monitoring devices, robots, a television, a home entertainment system and an intelligent appliance.

17. A system programmed in a controller in a device comprising:
a. a discovery module for discovering devices;
b. a profile generation module for generating a profile from information received form discovered devices;
c. a personalized remote user interface generation module for generating a personalized remote user interface using the profile; and
d. a providing module for providing the personalized RUI to a rendering device.

18. The system of claim 17 wherein the controller is selected from the group consisting of a programmed computer readable medium and an application-specific circuit.

19. A database device comprising:
a. a memory for storing an application, the application for:
i. entering device information and user information into a database;
ii. generating a profile by analyzing the device information and the user information;
iii. generating a personalized remote user interface based on the profile; and
iv. sending the personalized remote user interface to a rendering device; and
b. a processing component coupled to the memory, the processing component for processing the application.

20. The database device of claim 19 wherein entering the device information and the user information includes automatically receiving the device information and the user information from a user device.

21. The database device of claim 19 wherein entering the device information and the user information includes a user manually entering the device information and the user information.

22. The database device of claim 19 wherein the device information comprises at least one of a serial number, a MAC address, a device name and a device type.
